(19) United States
(12) Patent Application Publication
(10) Pub. No.: US 2016/0139636 A1
(43) Pub. Date: May 19, 2016

(54) ELECTRONIC APPARATUS

(71) Applicant: KABUSHIKI KAISHA TOSHIBA, Tokyo (JP)

(72) Inventors: Shunichi SAITO, Tokyo (JP); Keiichi Uehara, Tokyo (JP)

(73) Assignee: KABUSHIKI KAISHA TOSHIBA, Tokyo (JP)

(21) Appl. No.: 14/848,620

(22) Filed: Sep. 9, 2015

Related U.S. Application Data
(60) Provisional application No. 62/080,761, filed on Nov. 17, 2014.

(51) Int. Cl. G06F 1/16

(52) U.S. Cl. CPC G06F 1/1656; G06F 1/1605; G06F 1/1618; G06F 1/1643

(57) ABSTRACT

According to one embodiment, an electronic apparatus comprises, a first housing having a bottom surface placed on a mounting surface, a first operation portion, and a palmrest, and a second housing having a front surface provided with a second operation portion and a back surface. The electronic apparatus is convertible into a tablet style in which the second housing is overlapped on the first housing so that the bottom surface faces the back surface, and the first operation portion and the palmrest are directed to the mounting surface. The first housing has a nonslip portion protruded from a surface of the palmrest, the nonslip portion hitting the mounting surface in the tablet style.

### CROSS-REFERENCE TO RELATED APPLICATIONS

This application claims the benefit of U.S. Provisional Application No. 62/080,761, filed Nov. 17, 2014, the entire contents of which are incorporated herein by reference.

### FIELD

Embodiments described herein relate generally to an electronic apparatus.

### BACKGROUND

A convertible-type portable computer can be converted into a so-called tablet style in which a display equipped with a touchpanel is inverted to the rear side of a keyboard by 360 degrees.

When a portable computer converted into a tablet style is used by being placed on, for example, the top board of a desk, the keyboard faces the top board and the palmrest contacts the top board. Since the surface of the palmrest is a flat shape that has no concavity or convexity, the display is provided horizontally on the top board in a state where the portable computer is placed on the top board.

Therefore, it is impossible to tilt the input surface of the touchpanel so that the hand side of an operator is lowered. In addition, when the input surface is touched by a fingertip, a force transmitted from the fingertip to the input surface makes the portable computer easily moveable on the top board.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating a portable computer of a first embodiment converted into a notebook portable computer (PC) style;

FIG. 2 is an exemplary side view illustrating the portable computer in a state where a display is closed in the first embodiment;

FIG. 3 is an exemplary perspective view illustrating the portable computer of the first embodiment converted into a flat style;

FIG. 4 is an exemplary perspective view illustrating the portable computer of the first embodiment converted into a stand style;

FIG. 5 is an exemplary perspective view illustrating the portable computer of the first embodiment converted into a tablet style;

FIG. 6 is an exemplary side view illustrating the portable computer of the first embodiment converted into the tablet style;

FIG. 7 is an exemplary cross-sectional view illustrating a palmrest to which contacts of a nonslip portion are fixed in the first embodiment;

FIG. 8 is an exemplary perspective view illustrating a portable computer of a second embodiment in which a nonslip portion is provided in a palmrest;

FIG. 9 is an exemplary perspective view illustrating a portable computer of a third embodiment in which a nonslip portion is provided in a palmrest;

FIG. 10A is an exemplary cross-sectional view illustrating the palmrest to which a contact of the nonslip portion is fixed in the third embodiment;

FIG. 10B is an exemplary cross-sectional view along X-X line of FIG. 10A;

FIG. 11 is an exemplary perspective view illustrating a portable computer of a fourth embodiment in which a nonslip portion is provided in a palmrest;

FIG. 12 is an exemplary cross-sectional view illustrating a positional relationship between the palmrest to which contacts are fixed and speakers in the fourth embodiment;

FIG. 13 is an exemplary side view illustrating the portable computer of the fourth embodiment converted into a tablet style;

FIG. 14 is an exemplary perspective view illustrating a portable computer of a fifth embodiment in which a nonslip portion is provided around a palmrest;

FIG. 15 is an exemplary side view illustrating the portable computer of the fifth embodiment converted into a tablet style;

FIG. 16 is an exemplary perspective view illustrating a portable computer of a sixth embodiment in which a nonslip portion is provided around a palmrest;

FIG. 17 is an exemplary side view illustrating the portable computer of the sixth embodiment converted into a tablet style;

FIG. 18 is an exemplary perspective view illustrating a portable computer of a seventh embodiment in which a nonslip portion is provided around a palmrest; and

FIG. 19 is an exemplary side view illustrating the portable computer of the seventh embodiment converted into a tablet style.

### DETAILED DESCRIPTION

Various embodiments will be described hereinafter with reference to the accompanying drawings. In general, according to one embodiment, an electronic apparatus comprises: a first housing having a bottom surface placed on a mounting surface, an upper surface provided with a first operation portion which inputs information, and a palmrest provided frontward of the first operation portion; and a second housing having a front surface provided with a second operation portion which inputs information and a back surface positioned on a rear side of the front surface, the second housing being rotatably coupled to the first housing, wherein the electronic apparatus is convertible into a tablet style in which the second housing is overlapped on the first housing so that the bottom surface of the first housing faces the back surface of the second housing, the first operation portion and the palmrest of the first housing are directed to the mounting surface, and the second operation portion of the second housing is directed upward. The first housing has a nonslip portion protruded from a surface of the palmrest, the nonslip portion hitting the mounting surface in the tablet style.

### First Embodiment

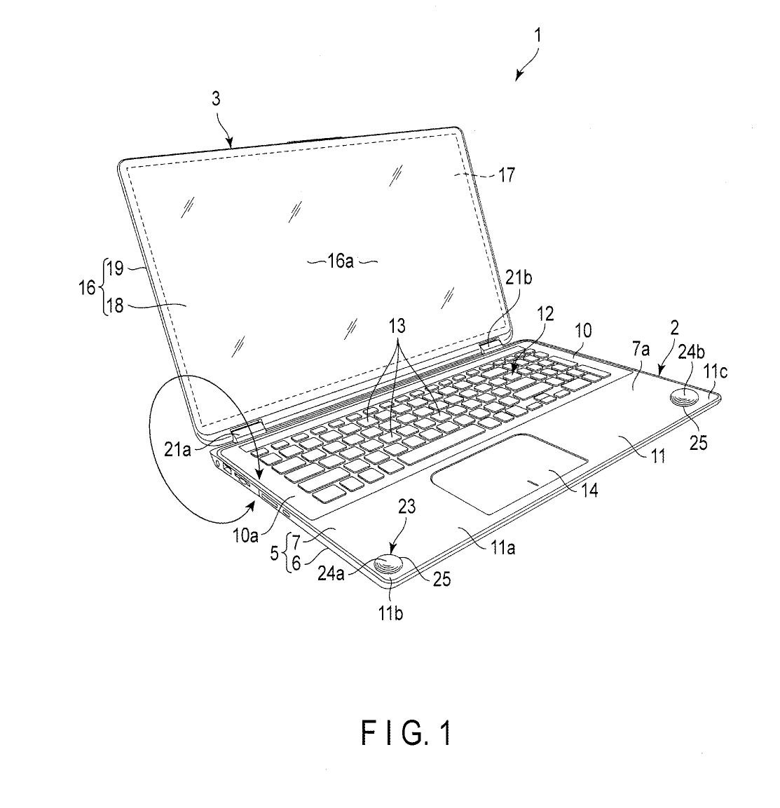

The first embodiment will hereinafter be described with reference to FIGS. 1 to 7.

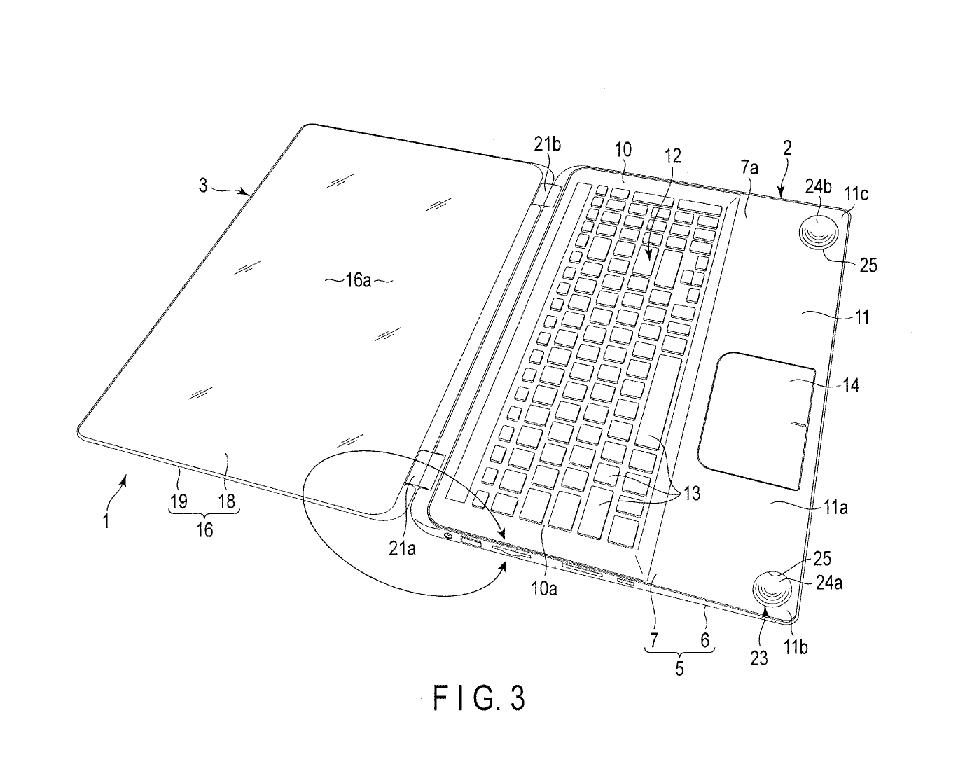

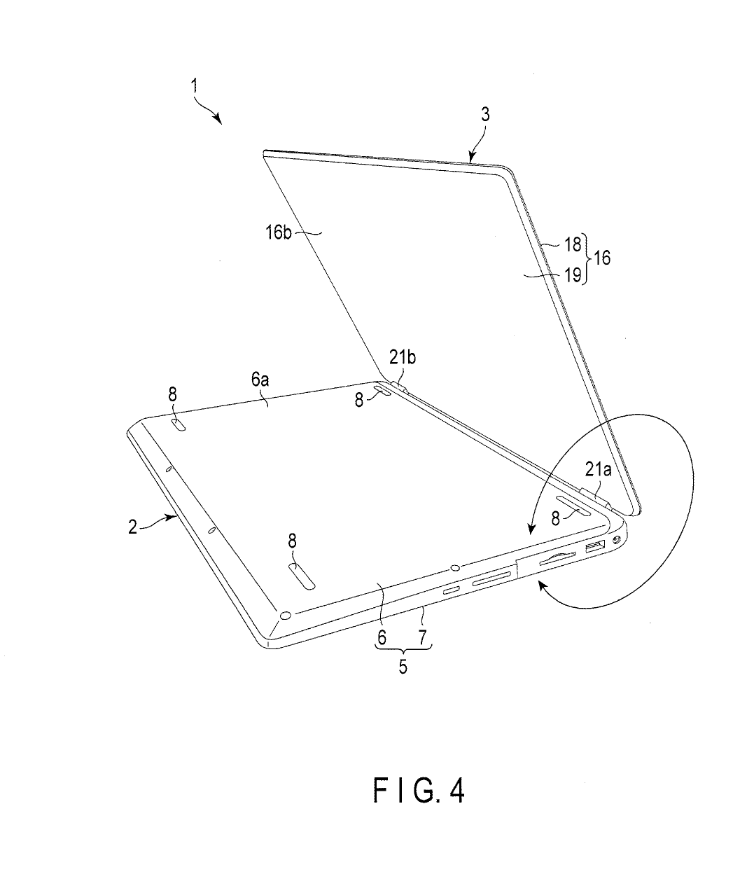

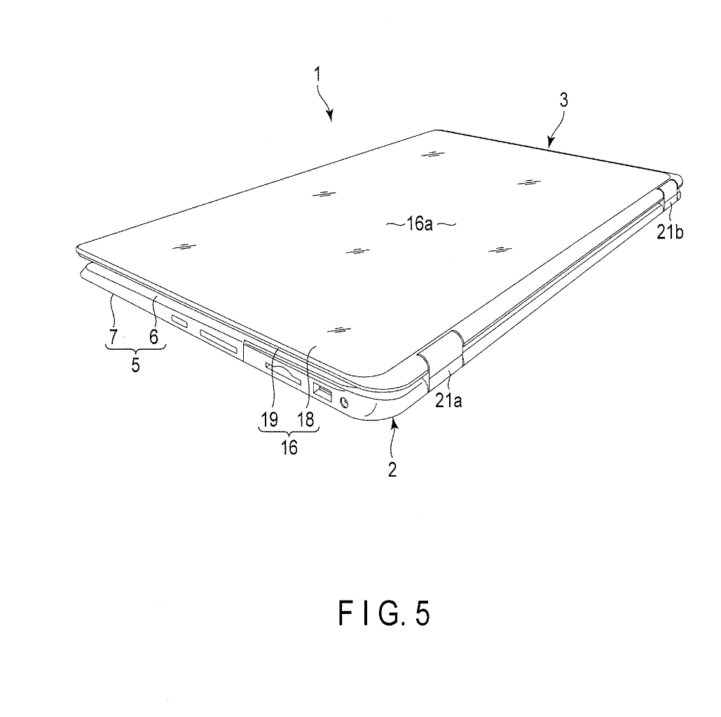

FIG. 1 discloses a convertible-type portable computer 1, which is an example of an electronic apparatus. The portable computer 1 is selectively convertible into a notebook PC style shown in FIG. 1, a flat style shown in FIG. 3, a stand style shown in FIG. 4 and a tablet style shown in FIG. 5.

The portable computer 1 includes a computer main body 2 and a display 3. The computer main body 2 is an element placed on, for example, a mounting surface 4 such as the top board of a desk, and includes a first housing 5. The first housing 5 has a flattened box shape and is made of a light weight, high-strength metal material such as aluminum alloy or magnesium alloy or of a synthetic resin material. The first housing 5 accommodates main constituting elements such as a mother board equipped with a CPU and a hard disk drive unit.

The first housing 5 is constituted by a bottom case 6 which has a bottom surface 6a and a top cover 7 which has an upper surface 7a. A plurality of feet 8 are fixed to the bottom surface 6a of the bottom case 6. The feet 8 are protruded from four corner portions of the bottom surface 6a so as to contact the mounting surface 4. The feet 8 are made of a rubber elastic body such as elastomer in order to prevent the first housing 5 from slipping to the mounting surface 4.

As shown in FIGS. 1 and 3, a keyboard attachment portion 10 and a palmrest 11 are provided on the upper surface 7a of the top cover 7. The keyboard attachment portion 10 extends in a width direction of the first housing 5 on the latter portion of the upper surface 7a of the top cover 7. The keyboard attachment portion 10 has a bottom 10a slightly recessed from the upper surface 7a of the top cover 7.

A keyboard 12 is provided on the keyboard attachment portion 10. The keyboard 12 is an example of a first operation portion and has a plurality of keytops 13. The keytops 13 are exposed on the bottom 10a of the keyboard attachment portion 10 and arranged with a gap with each other in a depth direction and a width direction of the first housing 5. Each key top 13 has a flat upper surface pressed by a fingertip.

The palmrest 11 is an element for placing the palm of the right hand and the palm of the left hand when an operator operates the keyboard 12. The palmrest 11 extends in a width direction of the first housing 5 on the former portion of the upper surface 7a of the top cover 7.

The palmrest 11 has a flat surface 11a which has no concavity or convexity. The outer peripheral portion of the keyboard attachment portion 10 which surrounds the surface 11a and the keytops 13 is positioned on the same plane. The upper surface of the keytop 13 is slightly more recessed than the surface 11a of the palmrest 11.

As shown in FIGS. 1 and 3, the surface 11a of the palmrest 11 has a first corner portion 11b and a second corner portion 11c. The first corner portion 11b is positioned on one end along a longitudinal direction of the palmrest 11. The second corner portion 11c is positioned on the other end along a longitudinal direction of the palmrest 11.

Further, a touchpad 14 is provided on the surface 11a of the palmrest 11. The touchpad 14 is positioned in the middle portion along a longitudinal direction of the palmrest 11.

The display 3 includes a second housing 16 and a touchpanel 17. The second housing 16 has a flattened box shape having substantially the same size as the first housing 5 and is formed thinner than the first housing 5.

The second housing 16 is constituted by a protection panel 18 and a back cover 19. The protection panel 18 is a flat board made of a transparent material such as glass and constitutes all of a front surface 16a of the second housing 16.

The back cover 19 is formed by a light weight, high-strength metal material such as aluminum alloy or magnesium alloy or formed by a synthetic resin material. The back cover 19 is positioned behind the protection panel 18 and constitutes a flat back surface 16b of the second housing 16.

The touchpanel 17 is an example of a second operation portion and is accommodated in the second housing 16. The touchpanel 17 is laminated on a liquid crystal display panel (not shown) and covered by the protection panel 18. The protection panel 18 works also as the input surface of the touchpanel 17 and the display surface of the liquid crystal display panel.

The second housing 16 of the display 3 is rotatably coupled to the first housing 5 of the computer main body 2 behind the keyboard 12. In the present embodiment, the computer main body 2 and the display 3 are coupled rotatably relatively by 360 degrees via a pair of two biaxial hinges 21a and 21b. Therefore, the display 3 is rotatable between a first position, a second position and a third position, with the pair of two biaxial hinges 21a and 21b as a fulcrum.

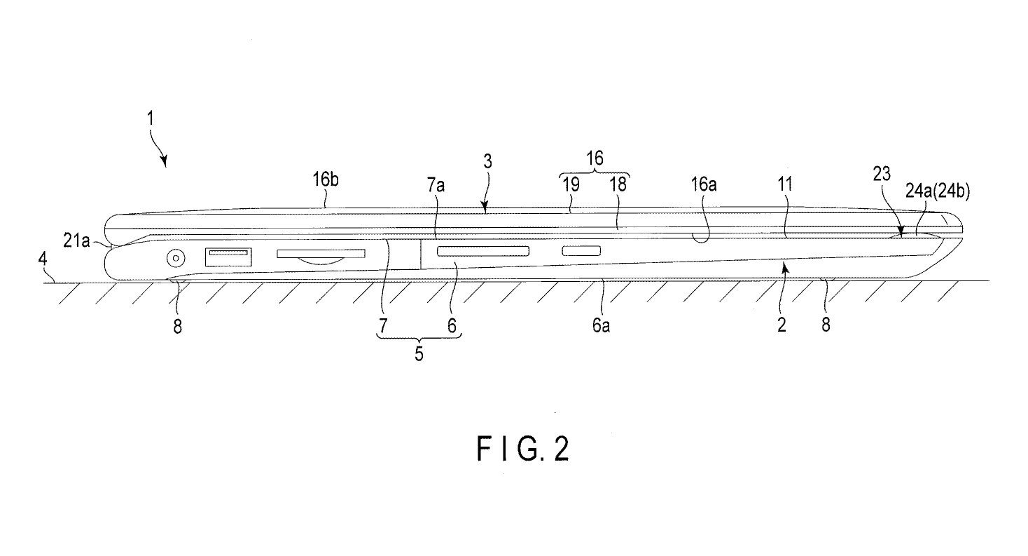

FIG. 2 illustrates a state where the display 3 is rotated to the first position. In the first position, the display 3 is laid down on the computer main body 2 so as to cover the palmrest 11 and the keyboard 12 from above. In other words, the display 3 is closed in the first position. Therefore, the back surface 16b of the second housing 16 of the display 3 is exposed and the protection panel 18 of the display 3 faces the palmrest 11 and the keyboard 12.

FIGS. 1, 3 and 4 disclose a state where the display 3 is rotated to the second position. In the second position, the display 3 is separated from the computer main body 2 without being overlapped with the computer main body 2.

Specifically, in the second position, the posture of the display 3 changes between a form where the display 3 is stood from the upper surface 7a of the computer main body 2 as shown in FIG. 1, a form where the display 3 is laid down horizontally behind the computer main body 2 as shown in FIG. 3, and a form where the display 3 is stood from the bottom surface 6a of the computer main body 2 as shown in FIG. 4.

Therefore, if the display 3 is stood from the upper surface 7a of the computer main body 2, the portable computer 1 is converted into a notebook PC style. Similarly, if the display 3 is laid down horizontally behind the computer main body 2, the portable computer 1 is converted into a flat style. In addition, if the display 3 is stood from the bottom surface 6a of the computer main body 2, the portable computer 1 is converted into a stand style.

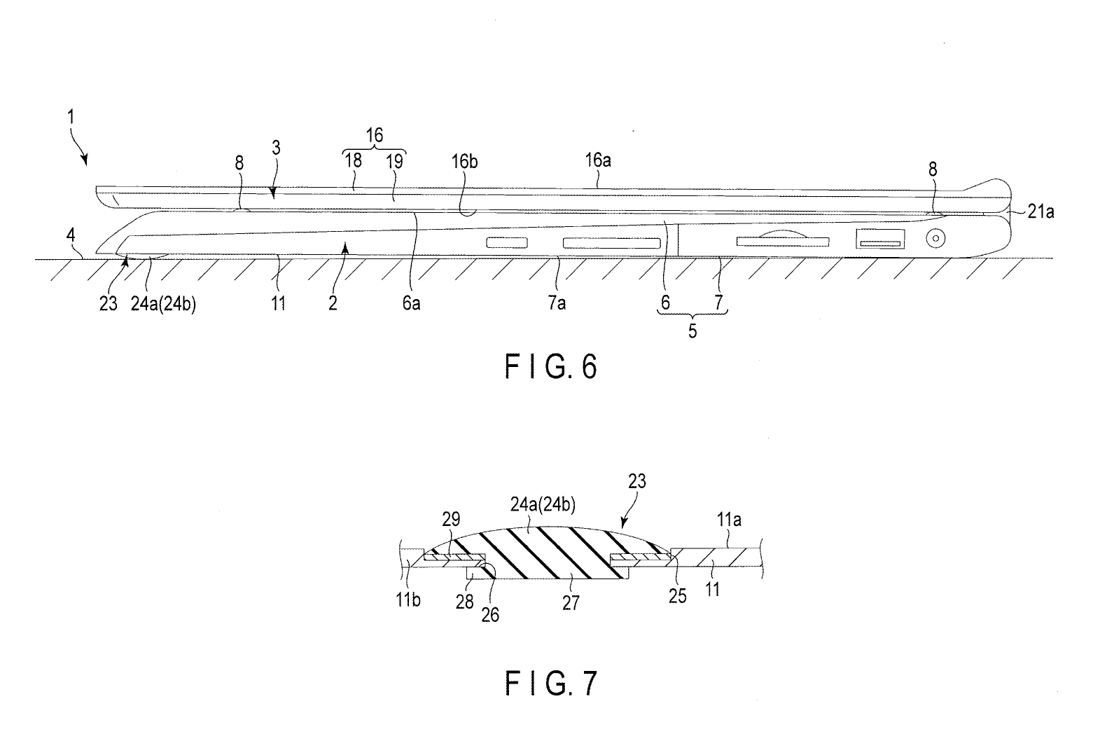

FIGS. 5 and 6 disclose a state where the display 3 is rotated to the third position. In the third position, the display 3 is overlapped with the computer main body 2 with each other so that the back surface 16b of the second housing 16 faces the bottom surface 6a of the first housing 5. In other words, the display 3 is overlapped on the computer main body 2 in a posture where the protection panel 18 which works as an input surface and a display surface is directed upward. The portable computer 1 is thereby converted into a tablet style.

As shown in FIGS. 1 and 3, the surface 11a of the palmrest 11 of the computer main body 2 is provided with a nonslip portion 23. The nonslip portion 23 has a pair of contacts 24a and 24b which are protruded from the surface 11a of the palmrest 11.

The one contact 24a is positioned in the first corner portion 11b of the palmrest 11. The other contact 24b is positioned in the second corner portion 11c of the palmrest 11. The contacts 24a and 24b are therefore separated from each other in a longitudinal direction of the palmrest 11.

Since the contacts 24a and 24b have a common structure, only the one contact 24a will now be described. The contact 24a is made of, for example, a rubber elastic body such as elastomer that has a higher coefficient of friction than the material which makes the first housing 5. The contact 24a of the present embodiment is formed in a disk shape.

As shown in FIG. 7, the contact 24a is fixed to the first corner portion 11b of the palmrest 11. Specifically, a circular concave portion 25 into which the contact 24a is fitted is formed in the first corner portion 11b of the palmrest 11. A through-hole 26 which penetrates through the palmrest 11 is formed on the bottom of the concave portion 25.

The contact 24a has a convex portion 27. The convex portion 27 penetrates through the through-hole 26 and a flange portion 28 formed on the tip end of the convex portion 27 is hooked to the inner surface of the palmrest 11. Further, the contact 24a is stuck to the bottom of the concave portion 25 by a double-stick tape 29.

The contact 24a of the present embodiment bulges spherically from the surface 11a of the palmrest 11. It is desirable that the curvature of a sphere formed by the contact 24a be made small as much as possible.

As shown in FIG. 2, the top portions of the contacts 24a and 24b elastically abut on the left side portion and the right side portion of the protection panel 18, in a state where the display 3 is rotated to the first position. In other words, the contacts 24a and 24b elastically receive the protection panel 18 of the second housing 16 when the display 3 is rotated from the second position to the first position. The contacts 24a and 24b thereby function as a buffer that absorbs an impact made to the display 3, when, for example, the display 3 is closed suddenly.

FIG. 6 illustrates a state where the portable computer 1 converted into a tablet style is placed on the mounting surface 4. In this state, the computer main body 2 is inverted so as to face the keytops 13 of the keyboard 12 and the palmrest 11 to the mounting surface 4, and the display 3 is overlapped on the computer main body 2. Therefore, the protection panel 18 of the display 3 is directed upward to the mounting surface 4 so that a desired input instruction can be performed by touching the protection panel 18 with a fingertip or pen.

According to the first embodiment, the nonslip portion 23 provided on the surface 11a of the palmrest 11 has the contacts 24a and 24b which bulge from the first corner portion 11b and the second corner portion 11c of the surface 11a. Therefore, if the portable computer 1 converted into a tablet style is placed on the mounting surface 4, the top portions of the contacts 24a and 24b hit the mounting surface 4 as shown in FIG. 6.

As a result, the palmrest 11 floats from the mounting surface 4 and the protection panel 18 of the display 3 can be tilted to a posture where the hand side of an operator is lowered. This makes the protection panel 18 easier to see and improves the operability of touching the protection panel 18 with a fingertip or pen.

Further, the contacts 24a and 24b of the nonslip portion 23 are made of a rubber elastic body which has a higher coefficient of friction than the material which makes the first housing 5. It is thereby possible to sufficiently secure friction resistance that occurs in the contacted portion between the contacts 24a and 24b and the mounting surface 4 so that the posture of the portable computer 1 placed on the mounting surface 4 is stabilized.

As a result, even if a force of touching the protection panel 18 with a fingertip is transmitted to the portable computer 1, it is difficult for the portable computer 1 to move on the mounting surface 4 so that the portable computer 1 is easy to use when used by being converted into a tablet style.

In addition, the contacts 24a and 24b of the nonslip portion 23 bulge from the surface 11a of the palmrest 11 with a small curvature. Therefore, when an operator places his right palm and left palm on the surface 11a of the palmrest 11, a sense of discomfort is less likely to occur even if the palms contact the contacts 24a and 24b, which never impairs the operability of the keyboard 12.

Also, since the contacts 24a and 24b of the nonslip portion 23 are in a form of being embedded into the concave portion 25 of the palmrest 11, the contacts 24a and 24b become less conspicuous. Therefore, since a sense of integrity of the contacts 24a and 24b and the palmrest 11 can be gained, there is no concern that the contacts 24a and 24b have adverse effects on the exterior and design of the portable computer 1.

While the front surface 16a of the display 3 is constituted by the protection panel 18 in the first embodiment, the protection panel may be surrounded by, for example, a frame-shape front bezel. According to this structure, when the display 3 is closed, the contacts 24a and 24b which also work as a buffer elastically receive the front bezel.

Further, concave portions into which the contacts 24a and 24b are fitted may be provided so that the bottoms of the concave portions receive the contacts 24a and 24b.

### Second Embodiment

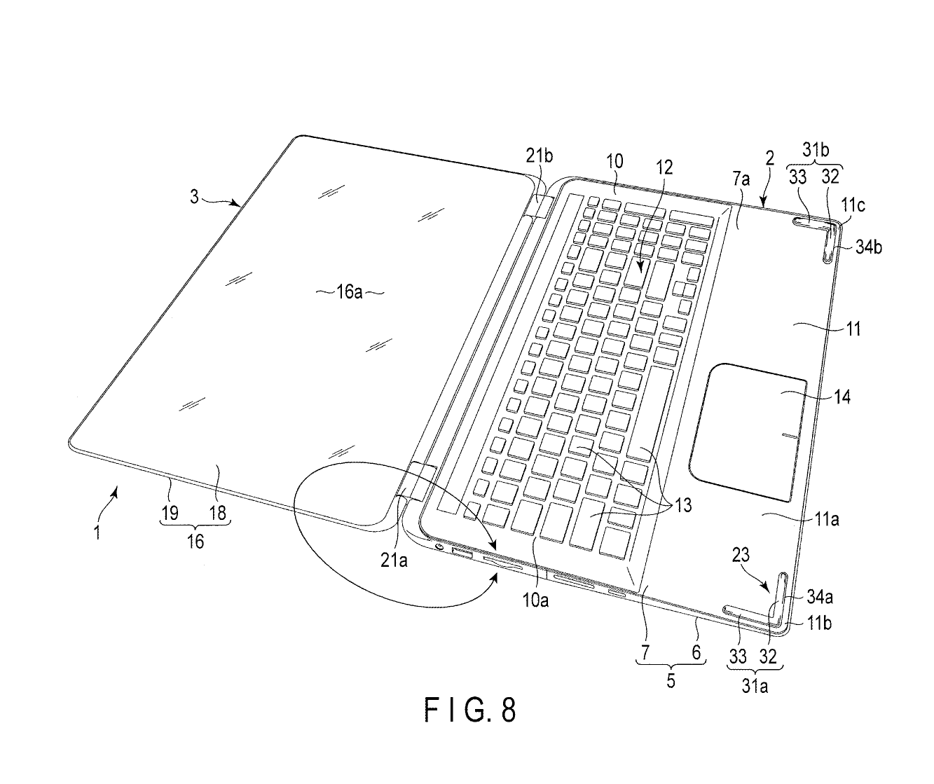

FIG. 8 discloses the convertible-type portable computer 1 of the second embodiment. The second embodiment differs from the first embodiment in the shapes of contacts 31a and 31b of the nonslip portion 23. Except for this, the basic structure of the portable computer 1 is the same as the first embodiment.

As shown in FIG. 8, the one contact 31a is positioned in the first corner portion 11b of the palmrest 11. The other contact 31b is positioned in the second corner portion 11c of the palmrest 11. The contacts 31a and 31b are made of, for example, a rubber elastic body such as elastomer that has a higher coefficient of friction than the material which makes the first housing 5.

The contacts 31a and 31b each have a first portion 32 which extends in a width direction of the first housing 5 and a second portion 33 which extends in a depth direction of the first housing 5 from one end of the first portion 32. One end of the first portion 32 and one end of the second portion 33 intersect perpendicularly with each other. Therefore, whereas the one contact 31a has a shape along the first corner portion 11b of the palmrest 11, the other contact 31b has a shape along the second corner portion 11c of the palmrest 11.

The contact 31a is fitted into a concave portion 34a provided in the first corner portion 11b and fixed to the palmrest 11 by a double-stick tape (not shown). Similarly, the contact 31b is fitted into a concave portion 34b provided in the second corner portion 11c and fixed to the palmrest 11 by a double-stick tape (not shown).

Further, the contacts 31a and 31b bulge spherically from the surface 11a of the palmrest 11. It is desirable that the curvature of a sphere formed by the contacts 31a and 31b be made small as much as possible.

According to the second embodiment, the top portions of the contacts 31a and 31b elastically abut on the left end portion and the right end portion of the protection panel 18, in a state where the display 3 is rotated to the first position. In other words, the contacts 31a and 31b elastically receive the protection panel 18 when the display 3 is rotated from the second position to the first position. The contacts 31a and 31b thereby function as a buffer that absorbs an impact made to the display 3, when, for example, the display 3 is closed suddenly.

If the portable computer 1 converted into a tablet style is placed on the mounting surface 4, the top portions of the contacts 31a and 31b which bulge spherically hit the mounting surface 4. The protection panel 18 of the display 3 can be thereby tilted to a posture where the hand side of an operator is lowered. As with the first embodiment, this makes the protection panel 18 easier to see and improves the usability of touching the protection panel 18 with a fingertip or pen.

In addition, the contacts 31a and 31b of the nonslip portion 23 have the first portion 32 which extends in a width direction of the first housing 5 and the second portion 33 which extends in a depth direction of the first housing 5. It is thereby possible to sufficiently secure a contacted area between the contacts 31a and 31b and the mounting surface 4 so that it is difficult for the portable computer 1 to move on the mounting surface 4 in a width direction and in a depth direction of the housing 5 when the protection panel 18 is touched by a fingertip.

This stabilizes the posture of the portable computer 1 placed on the mounting surface 4 and can improve the operability of using the portable computer 1 by being converted into a tablet style.

### Third Embodiment

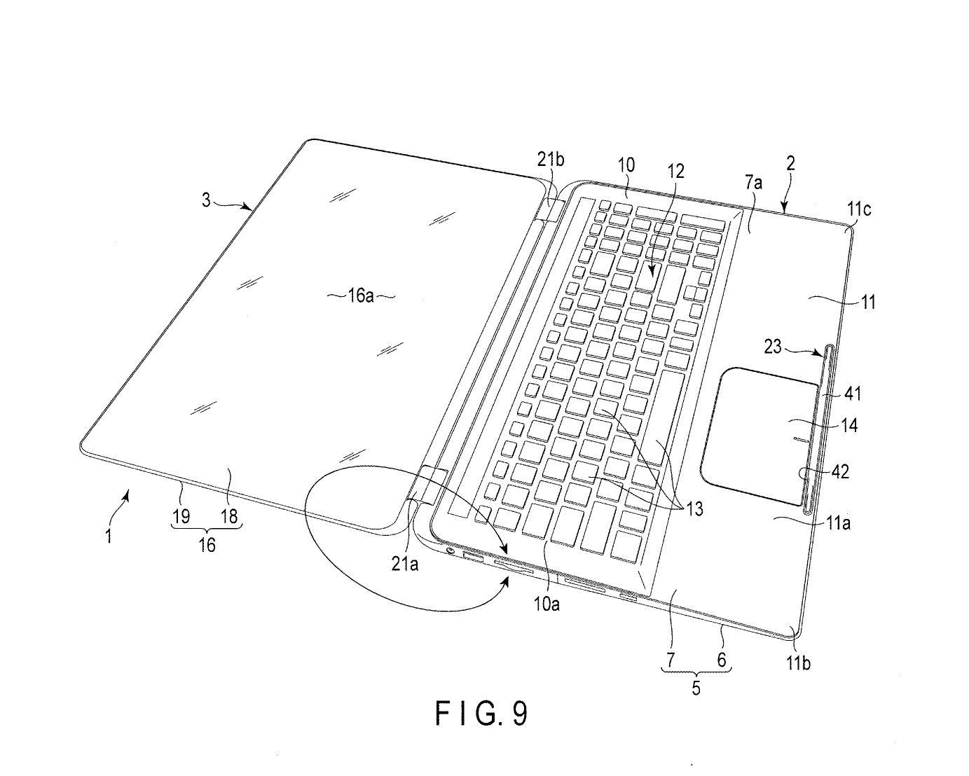

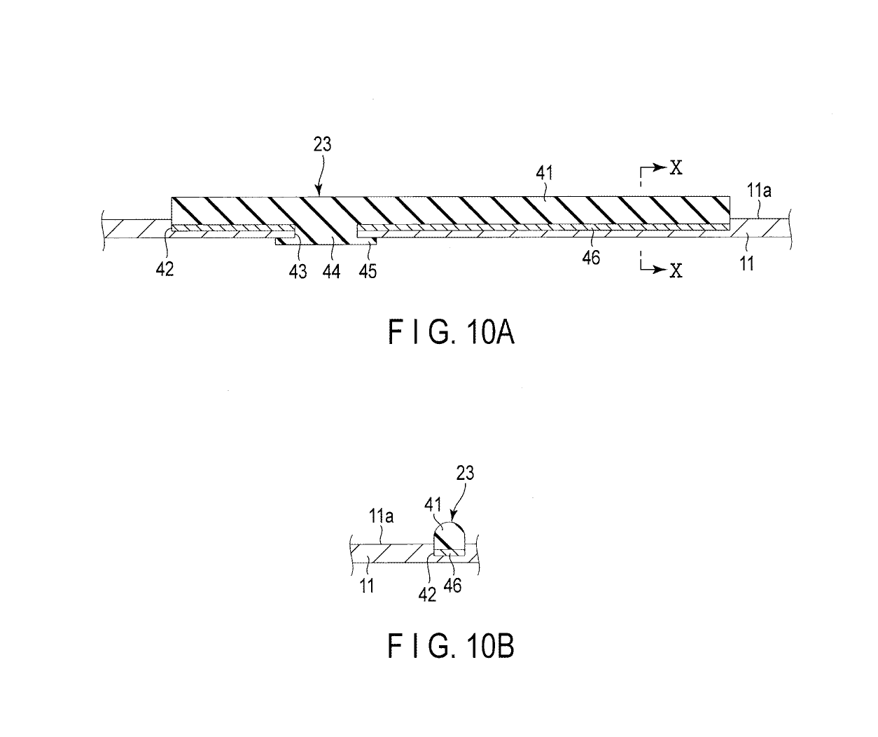

FIGS. 9, 10A and 10B disclose the third embodiment. In the third embodiment, the nonslip portion 23 has a single contact 41. The contact 41 has a linear shape extending in a longitudinal direction of the palmrest 11.

According to the present embodiment, the contact 41 is provided in a narrow area between the edge of the hand side of the palmrest 11 and the touchpad 14 and is separated from the first corner portion 11b and the second corner portion 11c of the palmrest 11.

As shown in FIGS. 10A and 10B, the contact 41 is fixed to the middle portion along a longitudinal direction of the palmrest 11. Specifically, a groove portion 42 into which the contact 41 is fitted is formed in the middle portion of the surface 11a of the palmrest 11. A through-hole 43 which penetrates through the palmrest 11 is formed on the bottom of the groove portion 42.

The contact 41 has a convex portion 44. The convex portion 44 penetrates through the through-hole 43 and a flange portion 45 formed on the tip end of the convex portion 44 is hooked to the inner surface of the palmrest 11. Further, the contact 41 is stuck to the bottom of the groove portion 42 by a double-stick tape 46. As shown in FIG. 10B most illustratively, the contact 41 of the present embodiment bulges in an arc shape from the surface 11a of the palmrest 11.

According to the third embodiment, the top portion of the contact 41 elastically abuts on the upper end portion of the protection panel 18, in a state where the display 3 is rotated to the first position. In other words, the contact 41 elastically receives the protection panel 18 when the display 3 is rotated from the second position to the first position. The contact 41 thereby functions as a buffer that absorbs an impact made to the display 3, when, for example, the display 3 is closed suddenly.

In the third embodiment, if the portable computer 1 converted into a tablet style is placed on the mounting surface 4, the contact 41 which bulges in an arc shape hits the mounting surface 4. The protection panel 18 of the display 3 can be thereby tilted to a posture where the hand side of an operator is lowered and the same effect as the first embodiment can be gained.

Further, in the present embodiment, the contact 41 is positioned in the middle portion along a longitudinal direction of the palmrest 11. When an operator places his right palm and left palm on the palmrest 11, the middle portion along a longitudinal direction of the palmrest 11 is an area just between the right palm and the left palm. Therefore, since it is difficult for the operator's palm to interfere with the contact 41 on the palmrest 11, the operator can operate the keyboard 12 without feeling discomfort.

In addition, the contact 41 is provided in a narrow area between the edge of the hand side of the palmrest 11 and the touchpad 14. Therefore, the contact 41 become less conspicuous and becomes convenient in terms of exterior of the portable computer 1.

### Fourth Embodiment

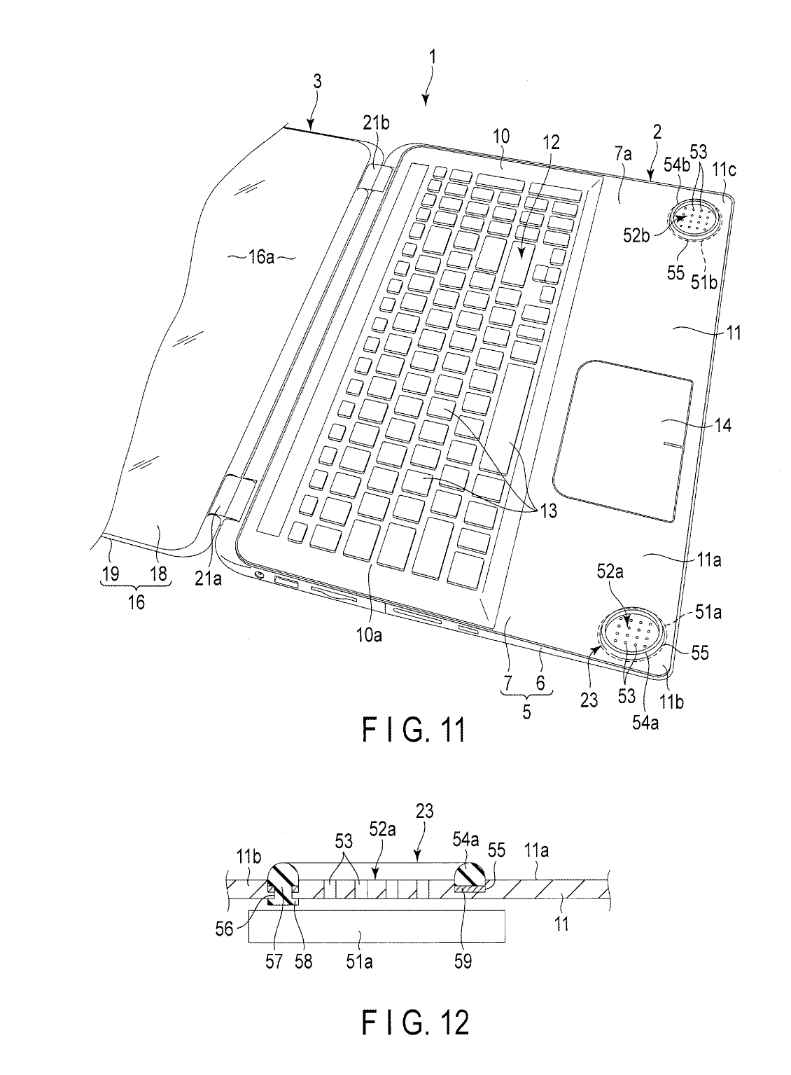

FIGS. 11 to 13 disclose the fourth embodiment. In the fourth embodiment, a pair of speakers 51a and 51b are accommodated inside the first housing 5. Whereas the one speaker 51a is positioned immediately below the first corner portion 11b of the palmrest 11, the other speaker 51b is positioned immediately below the second corner portion 11c of the palmrest 11.

A first sound-emitting portion 52a, which emits sound generated by the speaker 51a to the outside of the portable computer 1, is formed in the first corner portion 11b of the palmrest 11. Similarly, a second sound-emitting portion 52b, which emits sound generated by the speaker 51b to the outside of the portable computer 1, is formed in the second corner portion 11c of the palmrest 11.

The first sound-emitting portion 52a and the second sound-emitting portion 52b each have a plurality of through-holes 53 which penetrate through the palmrest 11. The through-holes 53 are arranged in a matrix in an area that faces the speakers 51a and 51b of the palmrest 11.

As shown in FIG. 11, the surface 11a of the palmrest 11 is provided with the nonslip portion 23. The nonslip portion 23 has a pair of contacts 54a and 54b which are protruded from the surface 11a of the palmrest 11. The one contact 54a is positioned in the first sound-emitting portion 52a of the palmrest 11. The other contact 54b is positioned in the second sound-emitting portion 52b of the palmrest 11.

Since the contacts 54a and 54b have a common structure, only the one contact 54s will now be described. The contact 54a is made of, for example, a rubber elastic body such as elastomer that has a higher coefficient of friction than the material which makes the first housing 5. The contact 54a of the present embodiment is formed in a ring shape to surround the first sound-emitting portion 52a consecutively.

As shown in FIG. 12, the contact 54a is fixed to the first sound-emitting portion 52a of the palmrest 11. Specifically, a ring-shaped concave portion 55 into which the contact 54a is fitted is formed in the first sound-emitting portion 52a of the palmrest 11. The concave portion 55 surrounds an area where the through-holes 53 are arranged and at least one fitting hole 56 which penetrates through the palmrest 11 is formed on the bottom of the concave portion 55.

The contact 54a has at least one convex portion 57. The convex portion 57 penetrates through the fitting hole 56 and a flange portion 58 formed on the tip end of the convex portion 57 is hooked to the inner surface of the palmrest 11. Further, the contact 54a is stuck to the bottom of the concave portion 55 by a double-stick tape 59. According to the present embodiment, the contact 54a of the present embodiment bulges in an arc shape from the surface 11a of the palmrest 11.

The bulging tip end portions of the contacts 54a and 54b elastically abut on the left side portion and the right side portion of the protection panel 18, in a state where the display 3 is rotated to the first position. In other words, the contacts 54a and 54b elastically receive the protection panel 18 when the display 3 is rotated from the second position to the first position. The contacts 54a and 54b thereby function as a buffer that absorbs an impact made to the display 3, when, for example, the display 3 is closed suddenly.

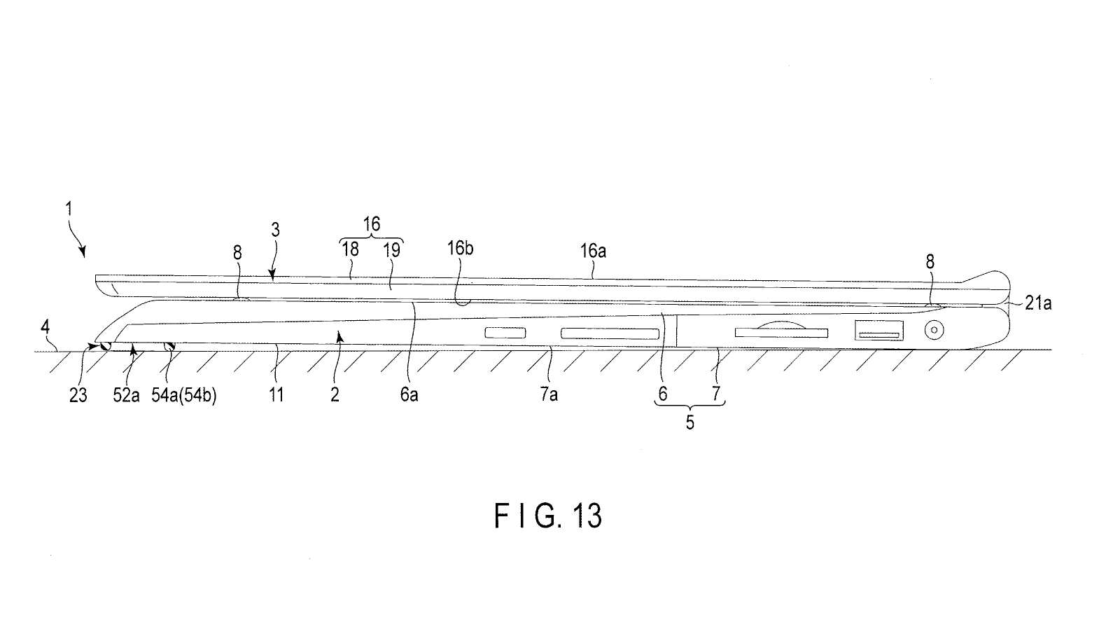

FIG. 13 illustrates a state where the portable computer 1 converted into a tablet style is placed on the mounting surface 4. In this state, the tip end portions of the contacts 54a and 54b which bulge in an arc shape from the surface 11a of the palmrest 11 hit the mounting surface 4. Therefore, the protection panel 18 of the display 3 can be tilted to a posture where the hand side of an operator is lowered and the same effect as the first embodiment can be gained.

Further, according to the fourth embodiment, the contacts 54a and 54b of the nonslip portion 23 are provided so as to surround an area where the through-holes 53 of the palmrest 11 are arranged. Therefore, it is possible to gain a sense of integrity of the contacts 54a and 54b and the first and second sound-emitting portions 52a and 52b and to actively introduce the nonslip portion 23 as one of the design elements of the portable computer 1.

In addition, the tip end portions of the contacts 54a and 54b which bulge from the surface 11a of the palmrest 11 are curved in an arc shape. Therefore, when an operator places his right palm and left palm on the surface 11a of the palmrest 11, a sense of discomfort is less likely to occur even if the palms contact the contacts 54a and 54b, which never impairs the operability of the keyboard 12.

### Fifth Embodiment

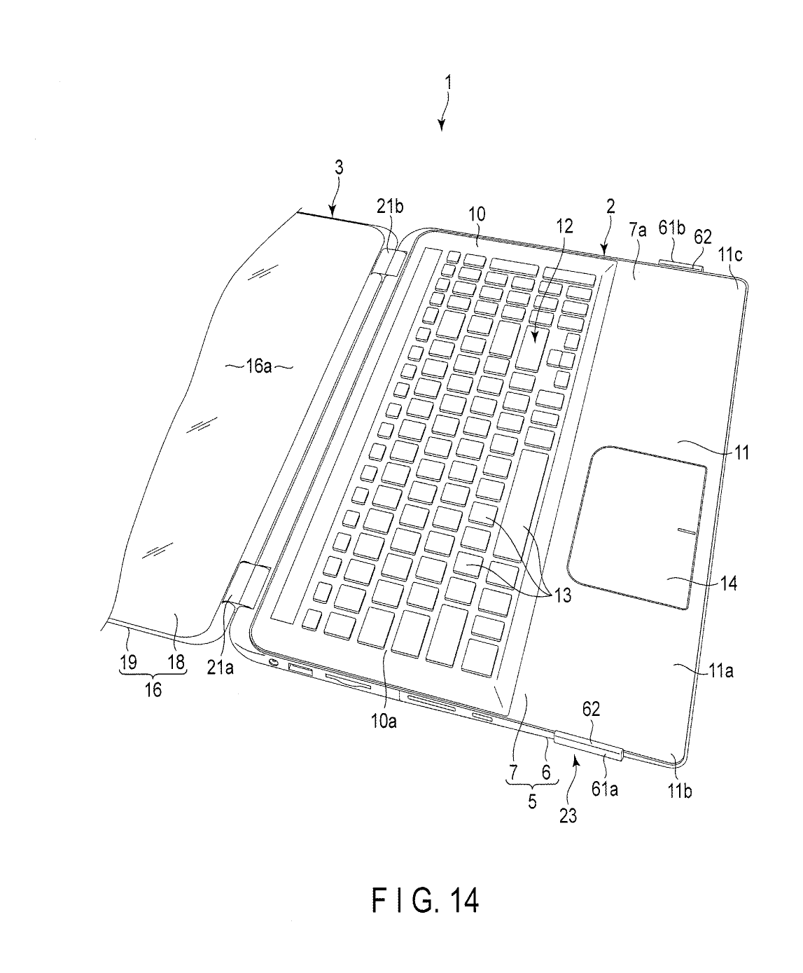

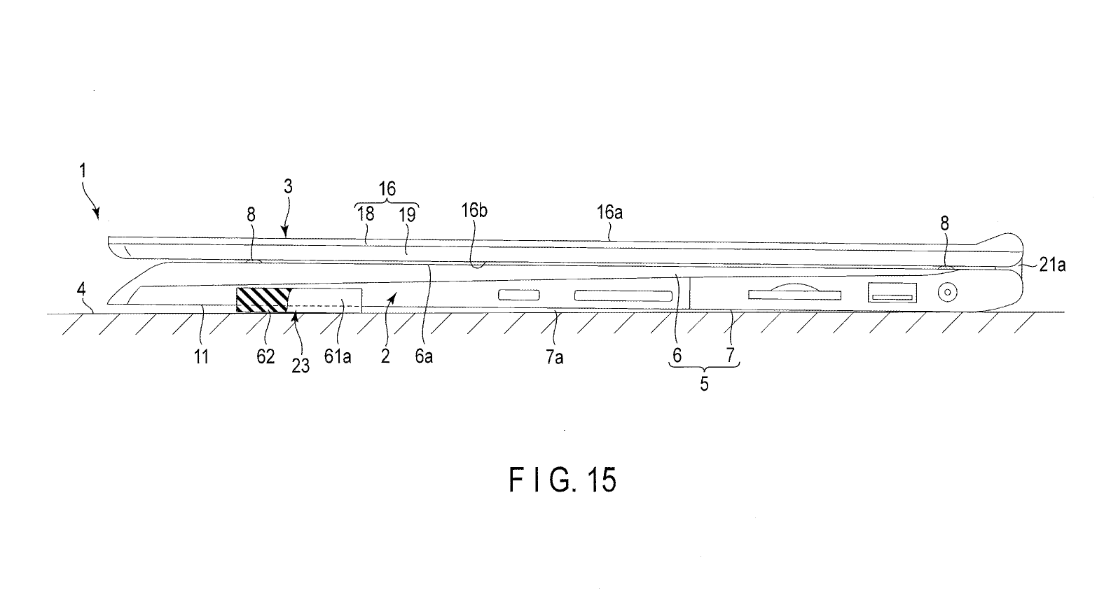

FIGS. 14 and 15 disclose the fifth embodiment. The fifth embodiment differs from the first embodiment in the nonslip portion 23. Except for this, the basic structure of the portable computer 1 is the same as the first embodiment.

As shown in FIG. 14, the nonslip portion 23 has a pair of contacts 61a and 61b. The contacts 61a and 61b are made of, for example, a rubber elastic body such as elastomer that has a higher coefficient of friction than the material which makes the first housing 5.

The one contact 61a is a linear element extending along the left side edge of the palmrest 11 and is fixed on the left side surface of the first housing 5 by a means such as adhesion. Similarly, the other contact 61b is a linear element extending along the right side edge of the palmrest 11 and is fixed on the right side surface of the first housing 5 by a means such as adhesion.

Therefore, the contacts 61a and 61b are separated from each other in a longitudinal direction of the palmrest 11 and positioned around the palmrest 11 which is separated from the surface 11a of the palmrest 11.

Further, the contacts 61a and 61b each have tip end portions 62 which are more protruded than the surface 11a of the palmrest 11. It is desirable that the tip end portions 62 of the contacts 61a and 61b be curved in, for example, an arc shape.

FIG. 15 illustrates a state where the portable computer 1 converted into a tablet style is placed on the mounting surface 4. In this state, the tip end portions 62 of the contacts 61a and 61b which are more protruded than the surface 11a of the palmrest 11 hit the mounting surface 4. Therefore, the protection panel 18 of the display 3 can be tilted to a posture where the hand side of an operator is lowered and the same effect as the first embodiment can be gained.

### Sixth Embodiment

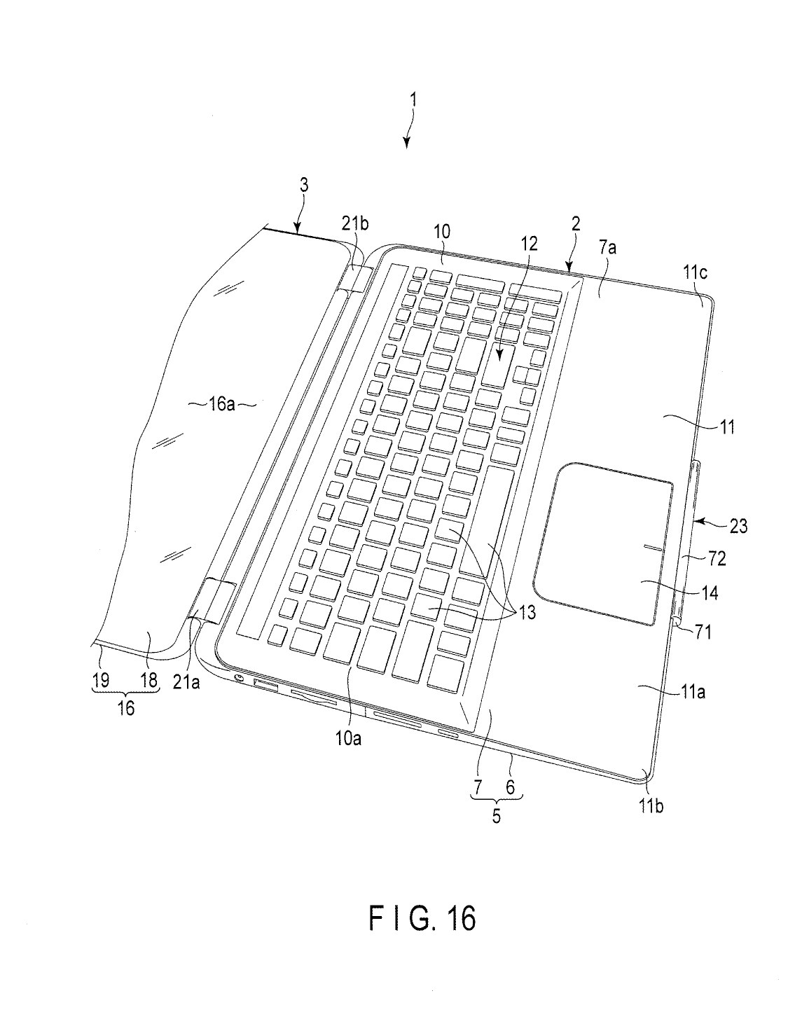

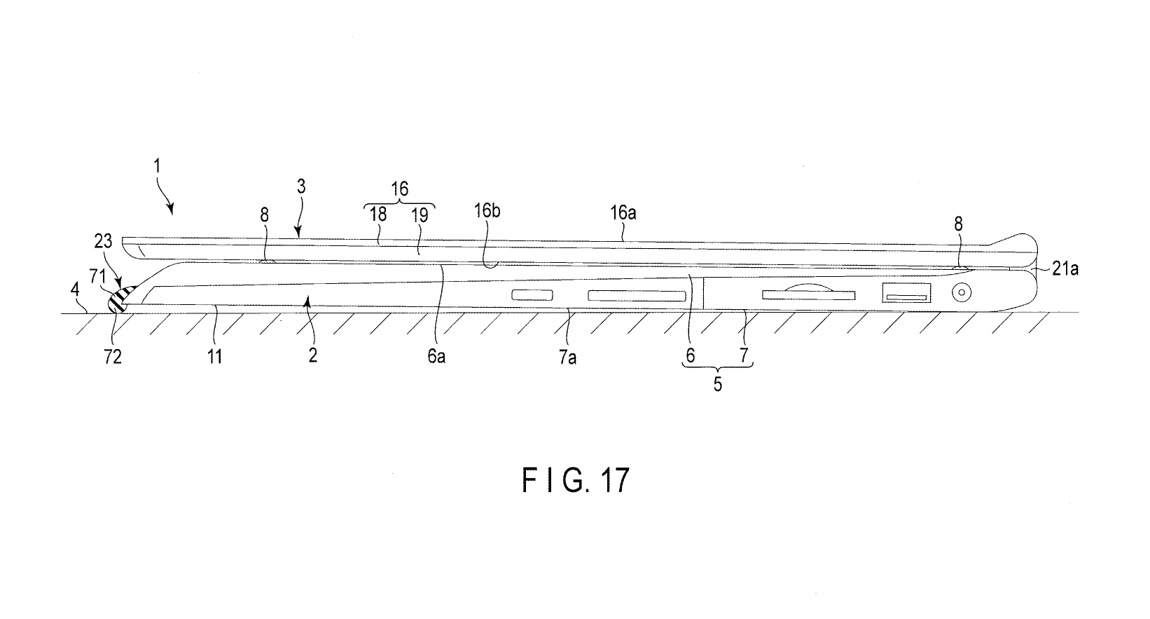

FIGS. 16 and 17 disclose the sixth embodiment. In the sixth embodiment, the nonslip portion 23 has a single contact 71. The contact 71 is made of, for example, a rubber elastic body such as elastomer that has a higher coefficient of friction than the material which makes the first housing 5.

The contact 71 is a linear element extending along the edge of the hand side of the palmrest 11. The contact 71 is fixed on the front surface of the first housing 5 by a means such as adhesion so as to be positioned in the middle portion along a longitudinal direction of the palmrest 11. Therefore, the contact 71 is positioned around the palmrest 11 which is separated from the surface 11a of the palmrest 11.

Further, the contact 71 has a tip end portion 72 which is more protruded than the surface 11a of the palmrest 11. It is desirable that the tip end portion 72 of the contact 71 be curved in, for example, an arc shape.

FIG. 17 illustrates a state where the portable computer 1 converted into a tablet style is placed on the mounting surface 4. In this state, the tip end portion 72 of the contact 71 which is more protruded than the surface 11a of the palmrest 11 hits the mounting surface 4. Therefore, the protection panel 18 of the display 3 can be tilted to a posture where the hand side of an operator is lowered and the same effect as the first embodiment can be gained.

### Seventh Embodiment

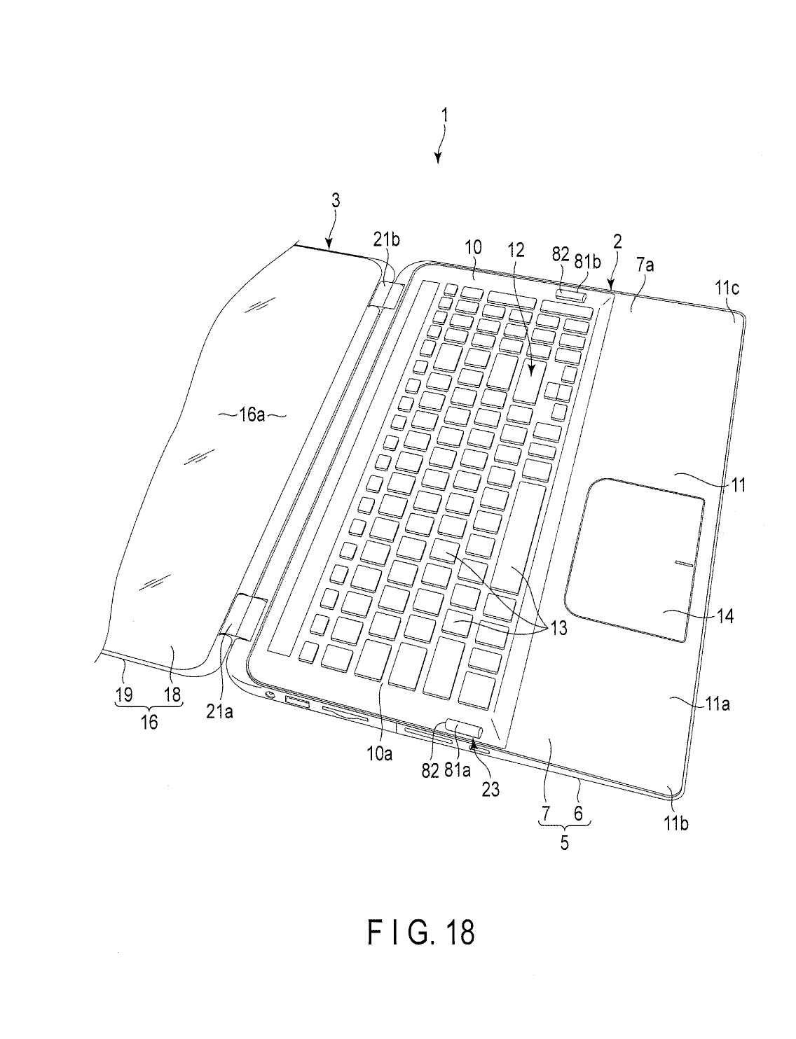

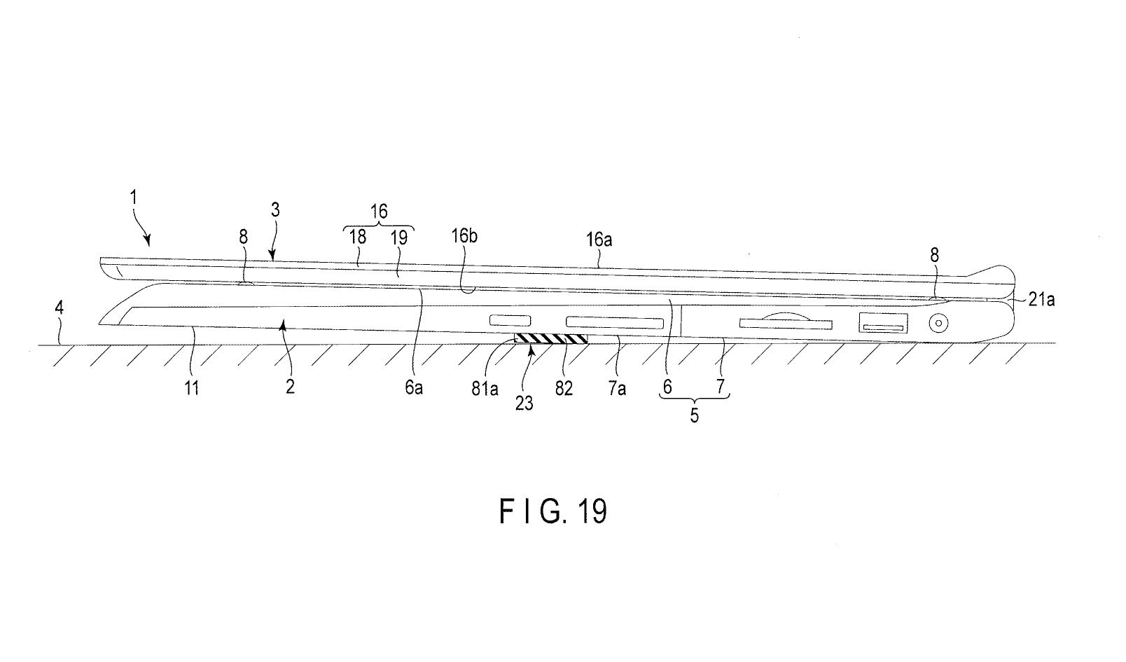

FIGS. 18 and 19 disclose the seventh embodiment. In the seventh embodiment, the nonslip portion 23 has a pair of contacts 81a and 81b. The contacts 81a and 81b are made of, for example, a rubber elastic body such as elastomer that has a higher coefficient of friction than the material which makes the first housing 5.

The one contact 81a extends in a linear fashion along a depth direction of the first housing 5 and is fixed to the left side portion of the bottom 10a of the keyboard attachment portion 10 by a means such as adhesion. The one contact 81a is adjacent to the keytops 13 positioned in the front row of the keyboard 12 on one end along a width direction of the first housing 5.

Similarly, the other contact 81b extends in a linear fashion along a depth direction of the first housing 5 and is fixed to the right side portion of the bottom 10a of the keyboard attachment portion 10 by a means such as adhesion. The other contact 81b is adjacent to the keytops 13 positioned in the front row of the keyboard 12 on the other end along a width direction of the first housing 5.

Therefore, the contacts 81a and 81b are positioned around the palmrest 11 which is separated from the surface 11a of the palmrest 11.

Further, the contacts 81a and 81b each have tip end portions 82 which are more protruded than the surface 11a of the palmrest 11. It is desirable that the tip end portions 82 of the contacts 81a and 81b be curved in, for example, an arc shape.

FIG. 19 illustrates a state where the portable computer 1 converted into a tablet style is placed on the mounting surface 4. In this state, the tip end portions 82 of the contacts 81a and 81b which are more protruded than the surface 11a of the palmrest 11 hit the mounting surface 4. Therefore, the protection panel 18 of the display 3 can be tilted to a posture where the hand side of an operator is lowered and the same effect as the first embodiment can be gained.

Further, according to the present embodiment, the tip end portions 82 of the contacts 81a and 81b elastically abut on the left side portion and the right side portion of the protection panel 18, in a state where the display 3 is rotated to the first position. In other words, the contacts 81a and 81b elastically receive the protection panel 18 of the second housing 16 when the display 3 is rotated from the second position to the first position. The contacts 81a and 81b thereby function as a buffer that absorbs an impact made to the display 3, when, for example, the display 3 is closed suddenly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first housing having a bottom surface placed on a mounting surface, an upper surface provided with a first operation portion which inputs information, and a palmrest provided frontward of the first operation portion; and
a second housing having a front surface provided with a second operation portion which inputs information and a back surface positioned on a rear side of the front surface, the second housing being rotatably coupled to the first housing, wherein
the electronic apparatus is convertible into a tablet style in which the second housing is overlapped on the first housing so that the bottom surface of the first housing faces the back surface of the second housing, the first operation portion and the palmrest of the first housing are directed to the mounting surface, and the second operation portion of the second housing is directed upward, and
the first housing has a nonslip portion protruded from a surface of the palmrest, the nonslip portion hitting the mounting surface in the tablet style.

2. The electronic apparatus of claim 1, wherein the nonslip portion is made of a material having a higher coefficient of friction than the first housing and is fixed to the palmrest.

3. The electronic apparatus of claim 2, wherein the nonslip portion elastically abuts on the front surface of the second housing when the second housing is rotated so that the front surface of the second housing faces the palmrest of the first housing.

4. The electronic apparatus of claim 3, wherein the second operation portion is a touchpanel having a flat protection panel which works also as an input surface, and all of the front surface of the second housing is constituted by the protection panel.

5. The electronic apparatus of claim 1, wherein the palmrest has an elongated shape extending in a width direction of the first housing and the nonslip portion includes a plurality of contacts separately arranged with each other in a longitudinal direction of the palmrest.

6. The electronic apparatus of claim 5, wherein the contacts of the nonslip portion have a shape which bulges from the surface of the palmrest.

7. The electronic apparatus of claim 5, further comprising a pair of speakers accommodated inside the first housing, wherein the speakers are separately arranged with each other in a longitudinal direction of the palmrest, the palmrest has a pair of sound-emitting portions which emit outside the first housing sound generated by the speaker in a position corresponding to the speakers, and the contacts of the nonslip portion are formed in a ring shape which surrounds the sound-emitting portions.

8. The electronic apparatus of claim 1, wherein the palmrest has an elongated shape extending in a width direction of the first housing and the nonslip portion is provided in a middle portion along a longitudinal direction of the palmrest.

9. The electronic apparatus of claim 1, wherein the first operation portion is a keyboard having a plurality of keytops, wherein the keytops have flat upper surfaces pushed by a fingertip and the upper surfaces of the keytops are more recessed than the surface of the palmrest.

10. An electronic apparatus comprising:
a first housing having a bottom surface placed on a mounting surface, an upper surface provided with a first operation portion which inputs information, and a palmrest provided frontward of the first operation portion; and
a second housing having a front surface provided with a second operation portion which inputs information and a back surface positioned on a rear side of the front surface, the second housing being rotatably coupled to the first housing, wherein
the electronic apparatus is convertible into a tablet style in which the second housing is overlapped on the first housing so that the bottom surface of the first housing faces the back surface of the second housing, the first operation portion and the palmrest of the first housing are directed to the mounting surface, and the second operation portion of the second housing is directed upward, and
the first housing has a nonslip portion more protruded than a surface of the palmrest around the palmrest, the nonslip portion hitting the mounting surface in the tablet style.

11. The electronic apparatus of claim 10, wherein the nonslip portion is made of a material having a higher coefficient of friction than the first housing, the nonslip portion being fixed to the first housing.

12. The electronic apparatus of claim 11, wherein the palmrest has an elongated shape extending in a width direction of the first housing and the nonslip portion includes a plurality of contacts separately arranged with each other in a longitudinal direction of the palmrest.

13. An electronic apparatus comprising:
a first housing having a bottom surface placed on a mounting surface and an upper surface provided with an operation portion which inputs information; and
a second housing having a display surface which works also as an input surface and a back surface positioned on a rear side of the display surface, the second housing being rotatably coupled to the first housing, wherein
the second housing is rotatable between a first position of being laid on the first housing so as to cover the operation portion, a second position of exposing the operation portion and the display surface, and a third position of being overlapped on the first housing so that the back surface of the second housing faces the bottom surface of the first housing, wherein
the electronic apparatus is convertible into a tablet style in which the operation portion of the first housing is directed to the mounting surface and the display surface of the second housing is directed upward in a state where the second housing is rotated to the third position, and
the first housing has a buffer which receives the display surface of the second housing when the second housing is rotated to the first position, the buffer tilting the display surface by hitting the mounting surface to a posture where a hand side of an operator is lowered in a tablet style in which the second housing is rotated to the third position.

14. The electronic apparatus of claim 13, wherein the buffer is made of a material having a higher coefficient of friction than the first housing and is fixed to the first housing.

15. The electronic apparatus of claim 13, further comprising a palmrest positioned frontward of the operation portion, wherein
the operation portion is a keyboard on which a plurality of key tops are arranged along a depth direction of the first housing right behind the palmrest, and
the buffer includes a pair of contacts which are more protruded than a surface of the palmrest, one contact being provided in a position adjacent to the keytops positioned in a front row of the keyboard on one end along a width direction of the first housing, and the other contact being provided in a position adjacent to the keytops positioned in a front row of the keyboard on the other end along a width direction of the first housing.

16. The electronic apparatus of claim 13, wherein the first housing further comprises a palmrest provided frontward of the operation portion and the buffer is more protruded than the surface of the palmrest.

17. The electronic apparatus of claim 16, wherein the buffer has a shape which bulges from the surface of the palmrest.
